(19) United States
(12) Patent Application Publication
(10) Pub. No.: US 2009/0254997 A1
(43) Pub. Date: Oct. 8, 2009

(54) Method and apparatus for content rights management

(76) Inventor: Fathy Fouad Yassa, Soquel, CA (US)

Correspondence Address: The Farrow Law Firm, Suite 500, 3031 Tisch Way, San Jose, CA, 95128, US

(21) Appl. No.: 12/387,648

(22) Filed: May 4, 2009

Related U.S. Application Data
(63) Continuation-in-part of application No. 11/233,515, filed on Sep. 21, 2005, now abandoned.

(51) Int. Cl. H04L 9/32; G06F 7/04

(52) U.S. Cl. 726/27; 380/28

(57) ABSTRACT

The instant invention relates to a method and apparatus for restricting access to digital content through the use of an exemplary form of digital encryption which ties the delivered content to a user, a specific destination device, a specific network, or one or more of the above. Specifically, the encryption/decryption keys are unique in each content consumption session, whether download or stream, which permits the content owner to provide multiple levels of access, i.e. different users may purchase different levels of access to the same content. For example, one user might want to use content on multiple playback devices, while another user might only need access on a single playback device.

### BACKGROUND OF THE INVENTION

During the analog age, owners of copyrighted audio and video content did not overly concern themselves about the unauthorized duplication of content by the average consumer. The nature of the analog medium prohibits most consumers from making a significant number of unauthorized duplicates because analog duplicates are always inferior to the source. Thus within a few generations, the duplicates are useless. Further, as most analog medium required physical contact with the playback device, the original source degraded each time a copy was made. Thus content owners generally did not expend significant resources in applying the few existing copy protection schemes to most analog content.

The advent of the digital age combined with cheap mass storage devices enabled the average user to make unlimited, near perfect duplicates from a given digital content source such as a CD or DVD. Thus, for the first time, owners and distributors of content had to contend with the average consumer having the power to mass-produce copyrighted digital content.

The proliferation of relatively inexpensive high speed telecommunications gave the average consumer the additional ability to mass distribute copyrighted content. Thus today, many consumers choose to download content, especially, music, via the public internet, in lieu of purchasing the content through authorized channels.

Owners of copyrighted content have responded utilizing a variety of technical means. They have placed electronic locks within the content which ostensibly prevents the unauthorized copying or distributing of copyrighted content. Today the use of technology to limit access to copyrighted content is known as digital rights management (DRM)

Digital rights management endeavors to return control over the distribution of copyrighted content to the copyright holder by making it difficult, if not impossible, to save, duplicate, or transmit, the restricted content. These methods were met with varying levels of success. One technique involves the user connecting to the content owner's internet server to periodically validate playback permission for content. Another method includes encoded expiration dates within the content.

Both methods have severe limitations. The former method requires an internet connection which effectively prevents the user of the content in a non-PC environment, such as a car stereo. The latter method has proven exceptionally easy to circumvent.

Today, the standard in digital rights management is the public/private key combination. In cryptography, a public key is a value provided by some designated authority as an encryption key that, combined with a private key derived from the public key, can be used to effectively encrypt messages and digital signatures. The use of combined public and private keys is known as asymmetric cryptography. A system for using public keys is called a public key infrastructure.

Hand held devices present special challenges for digital rights management. They often do not have internet connections for validating playback permission. Additionally, many modern devices have removable memory card which may permit the distribution of content without the content owner's permission.

Thus many digital rights management system include a method of validating content which is embedded within the content itself. These systems must validate both the length of time the content is authorized, but also who is authorized to view the content, and on what machine or machines, the content may be viewed.

Currently digital rights management systems fall into two classes. The former class restricts access to the content or service, the latter class encrypts the content itself. For purposes of this disclosure, encryption is the process of transforming information (referred to as content or rich media) using an algorithm to make it unreadable to anyone except those possessing special knowledge, usually referred to as a key. The result of the process is encrypted information. In this disclosure, the word decryption also implicitly refers to the reverse process, to make the encrypted information readable again (i.e. to make it unencrypted). Additionally digital rights management may utilize a combination of both classes.

Restricting access to content or services requires the potential user to validate that he or she is authorized to have access to the content. Typical validation systems include username/password combinations, router passphrases, and field validation e.g. DVD region codes, etc. Restricting access is very popular because it is very cheap and easy way to control content. Username/password type systems are fairly well known and can be easily implemented without much financial or computational cost. Consequently, this method can be used to restrict access to any type of content and especially rich media where the files tend to be large and encryption would be computationally intensive.

The limitation of merely restricting access is that if someone intercepts that content it may be fairly easy to read. For example, restricting access can be analogized to a locked briefcase containing very sensitive documents. If the lock is broken, the documents are wholly unprotected. This occurs often when wireless networks fail to take advantage of the various security options available. A third party can trespass on the wireless network and even intercept and view any unencrypted transmissions.

Therefore, for particularly sensitive content, copyright holders often encrypt the content itself, using a public/private key combination. There are many types of public/private key algorithms. Public key cryptography is a fundamental and widely used technology around the world, and is the approach which underlies such Internet standards as Transport Layer Security (TLS) (successor to SSL), PGP and GPG.

The distinguishing technique used in public key-private key cryptography is the use of asymmetric key algorithms because the key used to encrypt a message is not the same as the key used to decrypt it. Each user has a pair of cryptographic keys—a public key and a private key. The private key is kept secret, while the public key may be widely distributed. Messages are encrypted with the recipient's public key and can only be decrypted with the corresponding private key. The keys are related mathematically, but the private key cannot be feasibly (ie, in actual or projected practice) derived from the public key. It was the discovery of such algorithms which revolutionized the practice of cryptography beginning in the middle 1970s.

In contrast, Symmetric-key algorithms, variations of which have been used for some thousands of years, use a single secret key shared by sender and receiver (which must also be kept private, thus accounting for the ambiguity of the common terminology) for both encryption and decryption. To use a symmetric encryption scheme, the sender and receiver must securely share a key in advance.

Because symmetric key algorithms are nearly always much less computationally intensive, it is common to exchange a key using a key-exchange algorithm and transmit data using that key and a symmetric key algorithm. PGP, and the SSL/TLS family of schemes do this, for instance, and are called hybrid cryptosystems in consequence.

A simple (and impractical) example of a public/private key would be the child's algorithm of encoding messages by shifting letters by a fixed number. E.g., “A” becomes “B” and “B” becomes “C”, etc. So if the public key for the algorithm described in this paragraph is Increment by 1, then the private key, derived solely from the public key would be Decrement by 1. So the word “Patent” becomes “Qbufou” a wholly meaningless word. However, by applying the private key to it “Qbufou” reverts to Patent.

Content encryption takes longer than restricting access and requires more computer power and time. It is particularly well suited for small, extremely sensitive files such as e-mails. Content encryption is often used for downloaded rich media such as online movies. The content is encrypted once; send to the user, along with the key to unlock the content. In such a case, each user receives the identically encrypted content.

The limitation of this model is both technical and financial. Since each user downloads the identically encrypted content, it is impossible to limit access to a single machine or offer different levels of access.

As a further enhancement, some copyright holders have used the serial number of the user's video card as part of the encryption key. This was met with limited success, most notably as computer users routinely upgrade their computers, peripherals and cards are likely to be discarded thus making the content inaccessible.

### BRIEF DESCRIPTION OF THE INVENTION

The instant invention relates to a method and apparatus for restricting access to digital content through the use of an exemplary form of digital encryption which ties the delivered content to a user, a specific destination device, a specific network, or one or more of the above. Specifically, the encryption/decryption keys are unique in each content consumption session, whether download or stream, which permits the content owner to provide multiple levels of access, i.e. different users may purchase different levels of access to the same content. For example, one user might want to use content on multiple playback devices, while another user might only need access on a single playback device.

### DETAILED DESCRIPTION OF THE EMBODIMENTS

The present invention relates to an exemplary method of controlling access to digital media, residing on a computer system, destined for playback, storage, or re-transmittal to another computer system, by generating a private encryption key on the first computer system for the purpose of encrypting and decrypting said digital media content through the use of a standard encryption key generating algorithm and a seed, where said seed is obtained from the identifying information of the second computer system or destination device.

This present invention differs from previous content rights management system in that the server encrypts the requested content differently for each download or streaming session. Whereas in most content rights management system, including conditional access systems, the encryption is performed once by the content server and each destination device receives identically encrypted content.

FIG. 1 illustrates a high level block diagram of the system. Destination Device 130 requests content and a certain level of access via Request Channel 160. This request is routed through Internet 120 to the content provider's server, Server 110, via Delivery Channel 170. Server 110 has both Content 150 as well as Policy Engine 140 which delineates the maximum amount of access that a user can have over the delivered content. Server 110 queries Policy Engine 140 to determine what information is needed from Destination Device 130 in order to create a personalized encryption key to grant the requested level of access. Server 110 then queries Destination Device 130 to obtain the requested information to create a seed used to create a private key that will unlock the content and give the requested access to the content.

Keys are used to control the operation of a cipher or code (an algorithm for performing encryption and decryption) so that only the correct key can convert encrypted text (ciphertext) to plaintext. Many ciphers are based on publicly known algorithms or are open source, and so it is only the difficulty of obtaining the key that determines security of the system, provided that there is no analytic attack (i.e., a ‘structural weakness’ in the algorithms or protocols used), and assuming that the key is not otherwise available (such as via theft, extortion, or compromise of computer systems). In this disclosure a key may be fixed or variable length.

In this invention, every time the destination device attempts to access the content, a key is generated based upon the permissive usage policies and the user/destination device information. If the destination device attempts to decrypt and play the content in violation of the permissive usage policies, then the generated key won't be able to decrypt to content, or no key will be generated at all.

FIG. 2 illustrates a high level schematic diagram of the digital rights management system. Destination Device 270 requests access to content from Server 210. Server 210 queries Policy Engine 240 to obtain the permissive uses of the requested content. Policy Engine 240 returns the permissive uses, i.e. policy rules, to server 210, which transmits the permissive uses to Destination Device as well as a list of required information from the destination device for each level of access. Destination Device 270 transmits the required information to Server 210 which then creates a seed based on the permissive uses and destination device identification, then generates the encryption key from said seed.

Destination Device 270 knows which level of access was requested and the encryption algorithm being public, the Destination Device can determine the decryption key. Alternatively, Server 210 transmits the decryption key to Destination Device 270.

FIG. 3 illustrates a flow diagram of one embodiment of the invention. At Step 310, the Destination Device makes a request for access to content. The Destination Device transmits the relevant identification to the Server at Step 320. At Step 330, the Server obtains the policy rules for the requested content. Based on the identification information and the policy rules, a seed is created which is used by the computer systems to derive an encryption key is generated at step 340. At step 350, the server encrypts the content and transmits the encrypted content and policy rules to the destination device at step 360. At step 370, the destination device generates the decryption key. At step 380, the destination device decrypts the content for playback or viewing.

FIG. 4 illustrates a second embodiment of the invention. At Step 410, the destination device makes a request to the server for access to content. AT Step 420, the destination device transmits its identification information to the Server. At step 430, the server receives the policy rules for the requested content. At step 440 a seed is created which is used by the computer systems to derive an encryption key. The server then encrypts said key at step 450. At Step 460, the server transmits the policy rules, the encrypted content, and the encrypted key to the destination device. At Step 470, the destination device generates the key that will be used to decrypt the content protection key. At step 480, the content key is decrypted. At Step 490 the content is decrypted.

FIG. 5 illustrates an example of a policy algorithm. For purposes of this disclosure a policy algorithm is a simple numeric value which delineates the maximum access to content the user may have. For example, in the current disclosure, Fields 510x relates to the user limitations, Fields 520x relate to the machine limitations, Fields 530x relate to the location limitations. Location limitations may include or exclude. For example, a content provider may decide that his content can only be played in the United States. Conversely, the content provider may decide that his content cannot be played in the United States. When the destination device generates the key for playback, the seed used will include the location information in generating the decryption key. If the current location is not authorized by the permissive usage, then the decryption key will not work.

Field 540 relates to the temporal limitations such as expiration date. Field 510a stores the maximum number of users while Field 510b stores any age restrictions, i.e. adult content. Field 520a delineates the number of machines that the content can be authorized to play on, while Field 520b delineates any hardware limitations such as type of machine (e.g. cell phone, PDA, personal computer, television, etc.) certain brands, networks, and permissible software and hardware. Field 530a stores any country limitation. Country limitations may either include or exclude. For example, a content provider may limit the playback of contact to the United States. Conversely, the content provider may forbid playback within the United States. Field 530b stores the Zip code limitation. Field 530c stores any other geographic limitation that the content provider chooses to impose. As with Field 530a, Fields 530b and 530c may either include or exclude a geographic area.

FIG. 6 illustrates an example of the identification information that the destination device would send to the server. Field 610 stores the user information, e.g. user id and password, SIM card serial number; and biometrics such as Iris print, fingerprint, or voiceprint identification. Field 620 stores machine information such as MAC address, computer serial number, device make and model, processor id, device resources, etc. Field 630 stores the current geographical field of the destination device such as Zip code, IP address, cell tower information, GPS coordinates, proximity information such as landmarks.

FIG. 7 illustrates a sample key generated from the policy rules and identification information. Field 710 stores the username and password, field 720 the minimum age for viewing the content. Field 730 stores any biometric information such as fingerprints, voice prints, etc., Field 740 stores the destination device serial number(s), including the SIM card serial number. Field 750 stores the MAC address. Field 770 stores the computer make and model. Field 780 stores the IP address of the destination device. Field 790 stores the length of time that the content can be viewed, and fields 795 stores network information such as cellular vs. Wi-Fi and which cellular network.

### BRIEF DESCRIPTION OF THE DRAWINGS

FIG. 1 illustrates a high level block diagram of the system

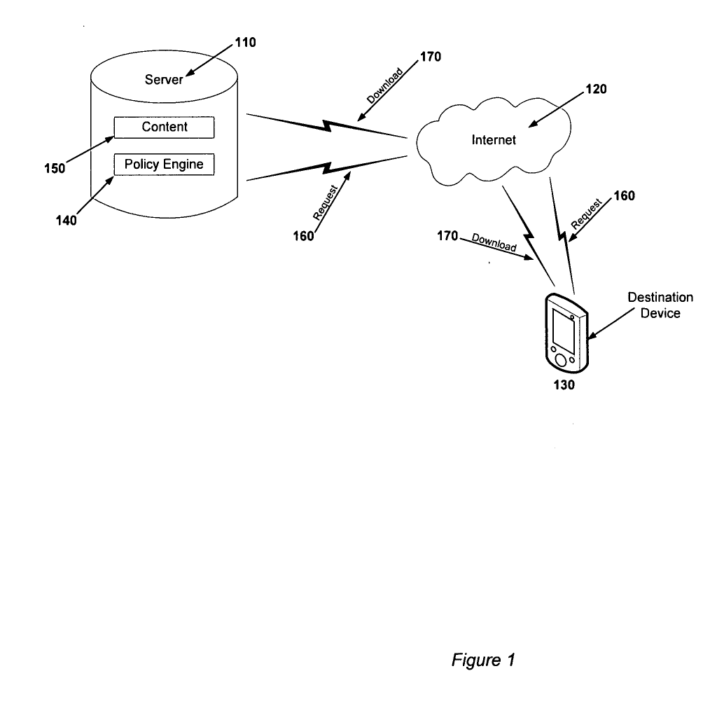

FIG. 2 illustrates a high level schematic diagram of the digital rights management system.

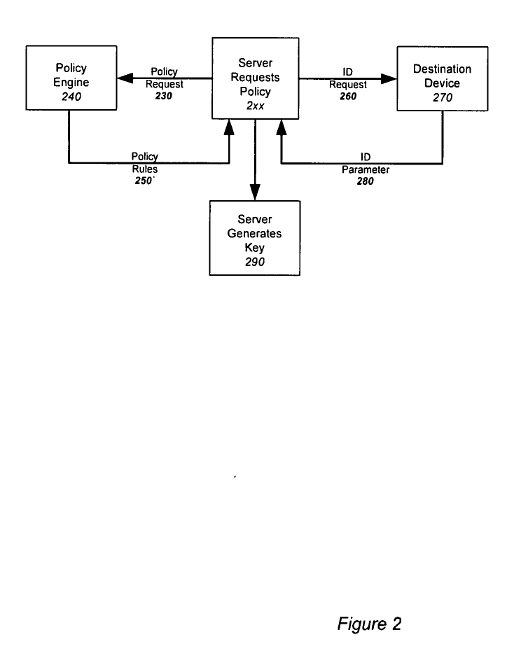

FIG. 3 illustrates a flow diagram of one embodiment of the invention by which the content itself is encrypted.

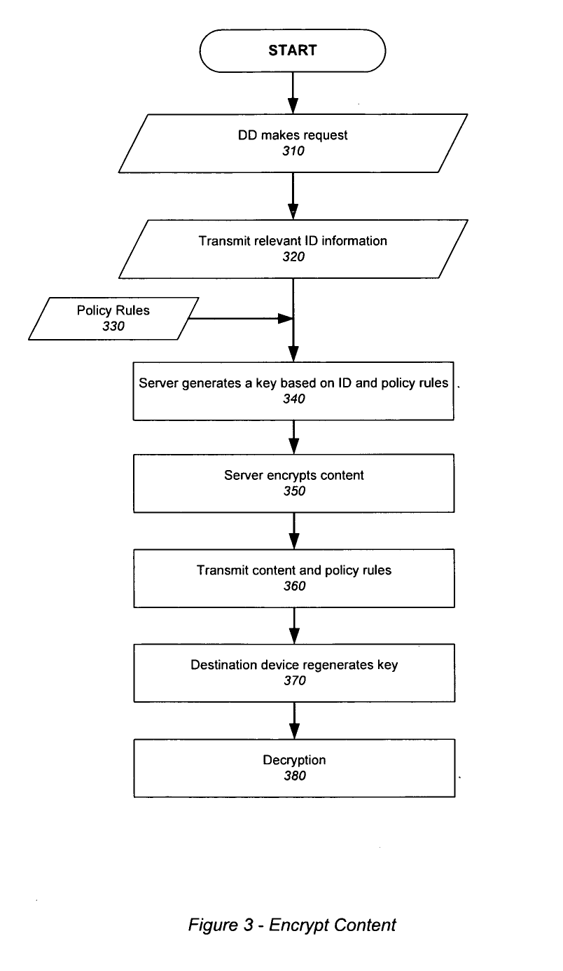

FIG. 4 illustrates a second embodiment of the invention by which the system encrypts the decryption key.

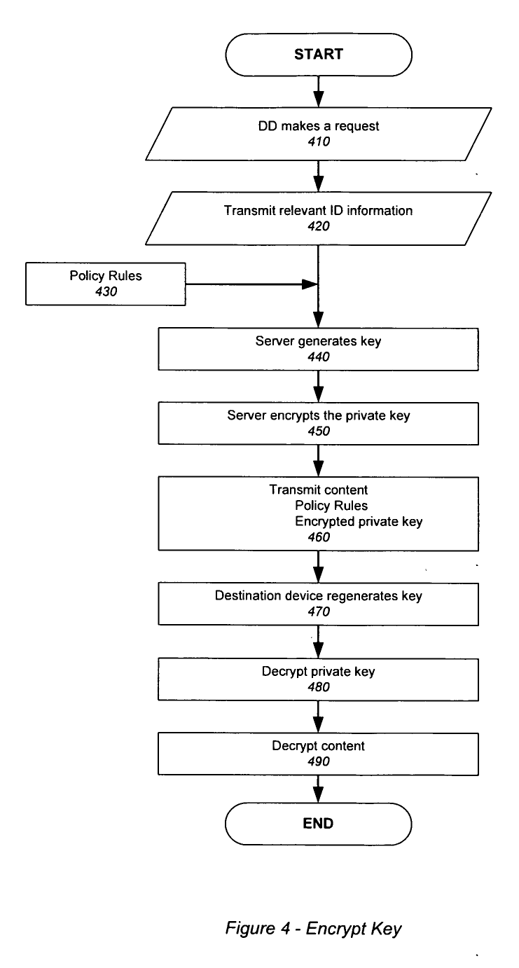

FIG. 5 illustrates a high level schematic diagram of a policy algorithm

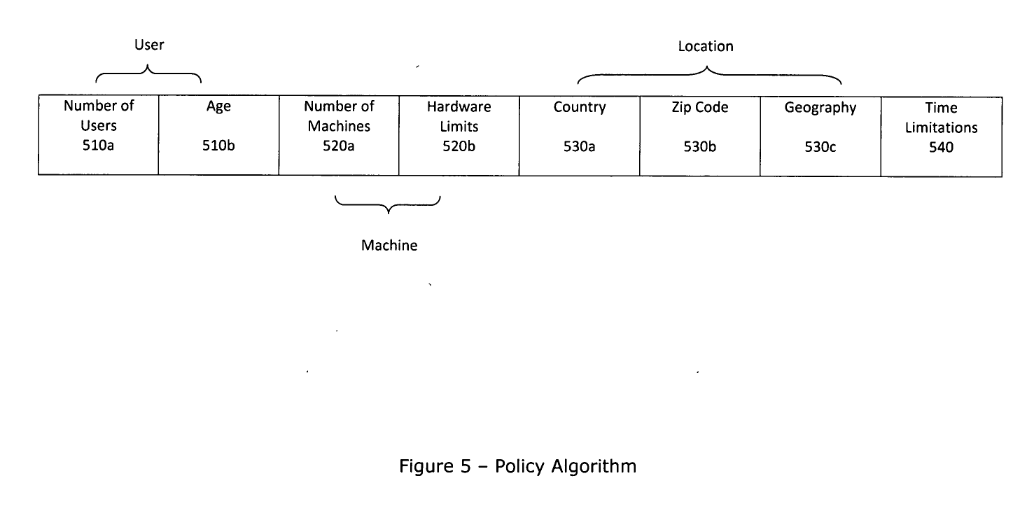

FIG. 6 illustrates a high level schematic diagram of the identification information that the destination device sends to the server.

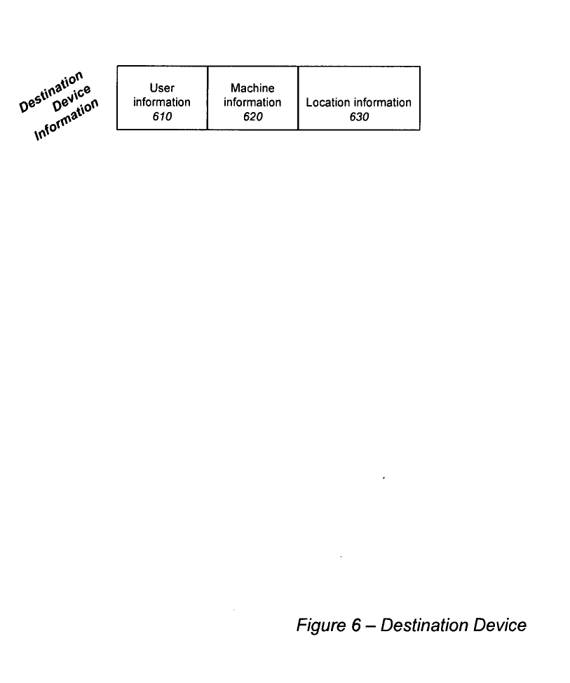

FIG. 7 illustrates a sample key generated from the policy rules and identification information.

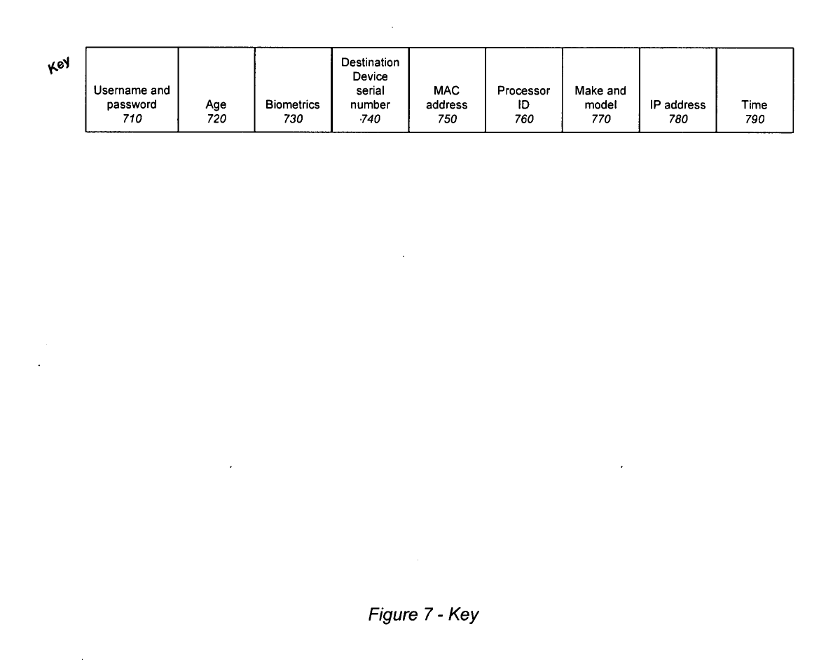

We claim:

1. A method of controlling access to digital media, residing on a first computer system, destined for playback, storage, or re-transmittal to another computer system, by generating a private encryption key on the first computer system for the purpose of encrypting and decrypting said digital media content through the use of a standard encryption key generating algorithm and a seed, where said seed is obtained from the identifying information of the second computer system.

2. The second computer system of claim 1, where the second computer system is a digital hand held device.

3. The digital media of claim 1, where said digital media is encrypted for playback, storage, or re-transmittal to another computer system, where said encryption is customized for each destination computer system.

4. The encrypted content of claim 3, where the decryption key is encrypted for transmittal to the second computer system, where said decryption key is encrypted differently for each destination computer system.

5. The encryption key of claim 1, where the seed is derived from the permissive usage policy.

6. The encryption key of claim 6, where the seed is further derived from the identification information of the second computer system.

7. The seed of claim 6, where said seed is derived from a combination of any one or more of the group consisting of user information, machine information, and location information.

8. The user information of claim 7, where the user information is a combination of any one or more of the group consisting of, user-id, password, service-subscriber key (IMSI) of Subscriber Identity Module (SIM) card, or biometric information.

9. The machine information of claim 7, where the machine information is a combination of any one or more of the group consisting of MAC address, machine make and model, machine serial number, machine CPU serial number, and machine resources.

10. The location information of claim 7, where the location information includes any combination of any one or more of the group consisting of machine zip code, the system assigned Internet Protocol (IP) address, cell tower information, GPS location, proximity.
